(19) United States
(12) Patent Application Publication
(10) Pub. No.: US 2024/0228020 A1
(43) Pub. Date: Jul. 11, 2024

(54) ELECTRIC AIR VEHICLE

(71) Applicant: Parviz Hamedanian, Fremont, CA (US)

(72) Inventor: Parviz Hamedanian, Fremont, CA (US)

(21) Appl. No.: 18/152,663

(22) Filed: Jan. 10, 2023

(51) Int. Cl. B64C 11/30; B64C 11/00; B64C 39/00

(52) U.S. Cl. CPC B64C 11/30; B64C 11/007; B64C 39/00

(57) ABSTRACT

The present invention is an electric air vehicle that uses a new kind of propeller referred to as rotor with circular solid disk shape with blades on one side of the rotor and flat surface on the opposite side. When the rotor is in rotation it has the advantage of exhibiting weightlessness and the air flow over the blades is smooth and occurs on one side of the rotor compare to existing propellers that air flows on both side of the blade. Flight control is achieved by mechanically tilting the rotor for the air vehicle pitch and roll movement without a need for additional flight control surfaces.

### CROSS REFERENCE TO RELATED APPLICATIONS

This application claims of the benefit of:
1) U.S. provisional application No. 63/298,754 filed on Jan. 12, 2022. The entire disclosure of the above application is hereby incorporated herein by reference.
2) U.S. provisional application No. 63/227,383 filed on Jul. 30, 2021. The entire disclosure of the above application is hereby incorporated herein by reference.
3) U.S. provisional application No. 63/192,034 filed on May 23, 2021. The entire disclosure of the above application is hereby incorporated herein by reference.

### FIELD OF INVENTION

The invention is in the field of aerospace, more specifically related to any air vehicle capable of vertical take-off and landing. The applications include but not limited to eVTOL (electric take-off and landing aircraft), drone, UAS (unmanned aircraft System), or large aircraft for personal or commercial use such as air-taxis, passenger aircraft, propellers for marines (boats and submarines), and military applications.

### BACKGROUND OF THE INVENTION

Many applications such as existing helicopters, single engine aircrafts, eVTOL, boats, and submarines all use propellers that have been invented more than two centuries ago. However, specifically airplane and marine propeller was invented in 1929 by John M Clark, patent #U.S. Pat. No. 1,864,803A. The propeller for helicopter was invented in 1932 by Pietro Trojani, patent #U.S. Pat. No. 1,867,733A. All inventions in regard to propellers are based on fundamentally same concept but different shape of blades.

What is common to all existing propellers is that the air flows on both sides of the blades in which operates with known efficiency of around 70% or lower. Since air flows on both side of the blade the leading edge of the blade cuts through air and cause noise. Additionally, the rotational speed of the blades is limited otherwise the tip of the blades will have supersonic speed with much higher noise than normal, especially in case of helicopters that blades have very long radius of rotation, in addition to blades having structural limitations in regard to high speed of rotation, which consequently limits the lifting capacity due to limited rotational speed.

One of the original goal of this invention was to find an alternative to helicopters that have been found very useful providing mobility for commercial, coastguard, and military applications. However, helicopter crashes are common as result of pilot error due to difficult flight control, and also mechanical failure due to having too many moving parts. Helicopters have blade span of average 30 feet to more than 50 feet in diameter which makes it not suitable to land in a congested areas and make it less accessible for every day commuting. The complex engineering design of helicopters drives up the manufacturing cost which financially makes it out of reach for most people and many small businesses to own or starting services such as air-taxis, even though there is a high demand for such services.

### BRIEF SUMMARY OF THE INVENTION

This invention relates to a new kind of propeller, herein referred to as rotor, that has number of advantages over the existing propellers including aerodynamic advantages in which air flows smoothly on one side of the blades to produce lift. Additionally, the invention uses a unique mechanism for flight control such as for pitching (elevating to higher altitude), or rolling (turning left or right) by activating electric/hydraulic actuators to mechanically tilt the rotor.

The preferred embodiment of this invention is for the air vehicles that uses only single propeller, as opposed to several, to be located at the bottom of the aircraft. Alternative embodiment is for rotor to be installed at the above the air vehicle fuselage. The present invention is an assembly of parts that includes the following list:
1) Central rotating shaft
2) Rotor, one or more to produce air lift
3) Actuators, to control rotor orientation for flight control.
4) Bearings, around the shaft
5) Pivot joint, attaching shaft to the main air vehicle cabin structure
6) Batteries
7) Electric motors
8) Gears, to transfer electric motor torque to the shaft

### BRIEF DESCRIPTION OF THE DRAWINGS

FIG. 1 shows perspective view of one example of preferred embodiment.

FIG. 2 shows perspective view of the preferred embodiment in transparent mode to show the rotor below the cabin.

FIG. 3 shows the preferred embodiment in a perspective view that more clearly shows the blades that are part of the rotor.

FIG. 4 shows more details of the rotor and the blades

FIG. 5 shows inside the rotor reinforced with structural beams

FIG. 6 shows one example of cabin structure

FIG. 7 shows the assembly below the cabin with a central shaft that is attached to the rotor.

### DETAILED DESCRIPTION OF THE INVENTION

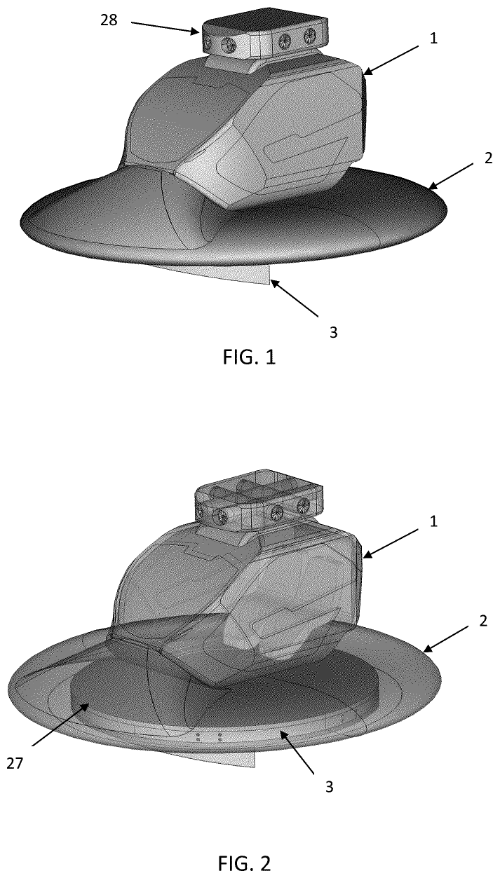

FIG. 1 shows perspective view of one example of preferred embodiment showing cabin 1 the rotor 3 and the rotor cover 2. The cabin is made of material in which examples are aluminum and carbon fiber reinforced composite. The rotor is made of material in which examples are aluminum, titanium, or steel. Air condition 28 is installed in which one example is at the top of the air vehicle.

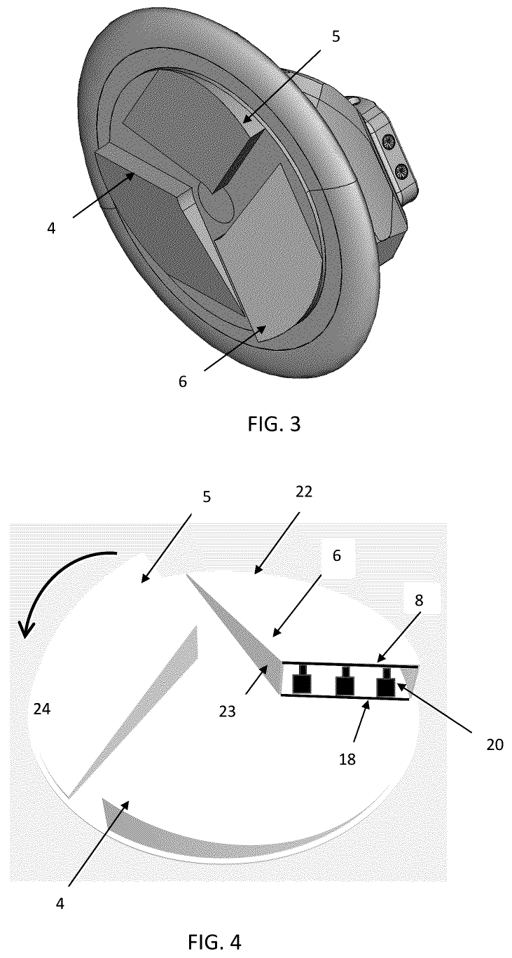

FIG. 2 shows the preferred embodiment in transparent mode. The rotor 3 is shown below the cabin in which when rotor 3 is in rotation it produces lift for the air vehicle.

FIG. 3 shows the blades 4, 5, 6 of the rotor 3 of FIG. 2. The blades 4, 5, and 6 have inclined surfaces to produce aerodynamic lift when rotor 3 is in rotation.

FIG. 4 shows more details of the rotor 3 and blades 4, 5, 6 that are manufactured in which an example is being machined as one part. The space inside the blades have cavity that in an alternative embodiment houses actuators that also function as shock absorber 20. In the same alternative embodiment, the blade surface at edge 8 is allowed to move toward edge 18 inside the channel 23 with series of special hinges along the edge 22 that not shown for preferred embodiment. For same alternative embodiment the purpose of allowed flexibility of movement of the blade surface at edge 8 is to prevent severe air turbulences causing shock to the air vehicle. Arrow 24 shows the rotational direction of the rotor 3 of FIG. 2.

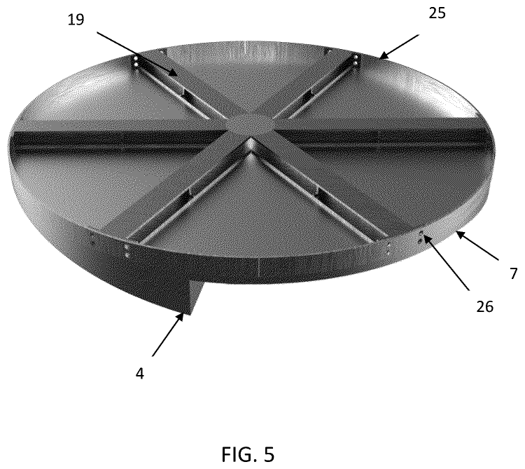

FIG. 5 shows inside of the rotor that structurally reinforced in which an example is by means of beams 19 made of material that an example would be aluminum, titanium, or steel attached to the circular disk wall 25 with fasteners 26 which commonly used for the upper disk 27 of FIG. 2 attachment to the wall 25. On the other side of the disk 7 the blades 4, 5, 6 of FIG. 3 are attached.

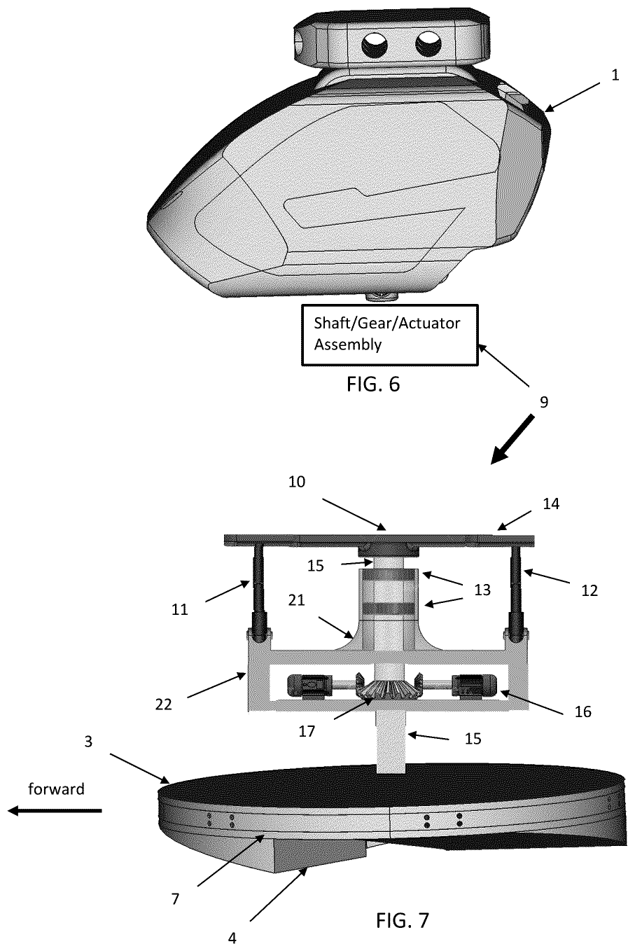

FIG. 6 shows cabin 1 and below it is item 9 that represent assembly of parts to be installed.

FIG. 7 shows the detailed assembly of item 9 of FIG. 6 attached to rotor 3. Structure 14 is part of the main structure of cabin 1 of FIG. 6. Shaft 15 is attached to cabin structure 14 by means of pivot joint 10. An example of pivot joint 10 is ball-and-socket joint to allow shaft 15 to rotate on its own axis while able to pivot in orientation other than vertical for purpose of mechanically controlling rotor 3 orientation for flight control.

Two rear linear actuators 12 (one on the left side and one on the right side of the air vehicle) and in the front two linear actuators 11 (one on the left side and one on the right side of the air vehicle) are attached to cabin structure 14 on the top and at the other end are attached to the shelf 22 that holds the motors 16. In this preferred embodiment there are only 4 actuators total. If the two linear actuators 12 on the aft side of the air vehicle are elongated and linear actuators 11 on the forward side of the air vehicle are equally shortened then rotor will tilt and propel the aircraft forward. Likewise, if linear actuators 11 and 12 on the left side of the aircraft elongated and linear actuators 11 and 12 of the right side shortened, then the rotor 3 orientation cause the aircraft to turn right.

Actuators 11 and 12 are activated by pilot to mechanically change the orientation of the rotor 3 for flight control. The cylindrical tube 21 is made of material in which an example would be aluminum, titanium that is bolted to shelf 22 at its base. Between tube 21 and shaft 15 there are two bearings 13 that allow shaft 15 to rotate around its own axis therefor put rotor 3 in rotation. Motor 16 that has its own gear is engaged with gear 17 that is attached to shaft 15 for applying torque force to the shaft 15.

What is claimed are:

1. The rotor that produces lift for the air vehicle is attached to the air vehicle structure by means of a pivot joint at the upper end of the rotating shaft in which one example would be ball-and-socket joint where the upper end of the shaft would be the ball furthermore in an alternative embodiment there could be more than one rotor installed beneath the air vehicle including one or more rotors in the vertical orientation at the rear of the air vehicle for additional forward thrust.

2. The rotor is a circular solid disk with two or more blades on one side of the disk where the blade's surface makes an angle in respect to the rotor so that when disk is in rotational movement the air flows over the inclined surface of the blades to produce lift, while the upper side of the rotor is flat, furthermore in an alternative embodiment in which the angle between inclined blade's surface and the disk could change for flight maneuver or to avoid shock to the air vehicle from air turbulences by installing actuators that also function as shock absorber inside the cavity between the inclined surface of the blade and the disk.

3. The flight control for the air vehicle pitch and roll is accomplished by mechanically tilting the rotor in which one example would be through four or more actuators tilting the rotor for desired flight control. the rotating shaft is attached to the air vehicle structure by means of pivot joint while structurally secured in which an example is shaft positioned inside a cylindrical housing by two or more bearings in the space between the shaft and the cylinder to allow shaft to rotate in its own axis when motor applies torque to the gear attached to the shaft.
